(19) United States
(12) Patent Application Publication
(10) Pub. No.: US 2007/0146924 A1
(43) Pub. Date: Jun. 28, 2007

(54) Portable electronic apparatus containing hard disk drive and power saving control method for use in the apparatus

(75) Inventor: Hisaya Nishioka, Hamura-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/637,426

(22) Filed: Dec. 11, 2006

(30) Foreign Application Priority Data
Dec. 26, 2005 (JP) 2005-373306

(51) Int. Cl. G11B 21/02

(52) U.S. Cl. 360/75

(57) ABSTRACT

According to one embodiment, a portable electronic apparatus contains a hard disk drive (HDD). The HDD includes a head used to read/write data from/to a recording medium. An acceleration detection circuit detects acceleration undergone by the portable electronic apparatus, and controls the HDD to retract the head from above the recording medium, based on the detected acceleration. A CPU estimates whether the head is retracted from above the recording medium, based on a power mode set for an interface incorporated in the HDD. A controller sets the acceleration detection circuit in a power saving mode when it is estimated that the head is retracted.

### CROSS-REFERENCE TO RELATED APPLICATIONS

This application is based upon and claims the benefit of priority from Japanese Patent Application No. 2005-373306, filed Dec. 26, 2005, the entire contents of which are incorporated herein by reference.

### BACKGROUND

1. Field

One embodiment of the invention relates to a portable electronic apparatus containing a hard disk drive, and more particularly, to a portable electronic apparatus suitable for power saving of an acceleration detection circuit used to protect the hard disk drive from, for example, an impact, and also relates to a power saving control method employed in the apparatus.

2. Description of the Related Art

Portable electronic apparatuses, such as notebook personal computers, which can be powered by a battery, are known as those containing a hard disk drive (HDD). These apparatuses generally incorporate an acceleration detection circuit. The acceleration detection circuit detects (predicts) vibration, impact and free fall, etc., of the electronic apparatus to protect the HDD. The acceleration detection circuit incorporates an acceleration sensor.

Upon predicting the occurrence of, for example, impact affecting the HDD, the acceleration detection circuit retracts the head (magnetic head) of the HDD from above the recording medium (magnetic disk) to a preset area. At this time, the HDD is shifted to a crashproof state (HDD protection state) in which data reading/writing is disabled. This prevents the head or recording medium from being damaged because of, for example, impact.

Many of the above-mentioned portable electronic apparatuses that can be powered by a battery have a function for switching the state to a power saving state. To switch the electronic apparatus to the power saving state (such as hibernation), it is necessary to store the contents of the main memory in the HDD. However, there may be a case where after the HDD is shifted to the crashproof state, the acceleration detection circuit cannot issue, for a long time, the prediction that the danger of impact has gone away. In this case, since the contents of the main memory cannot be stored in the HDD, the electronic apparatus cannot be shifted to the power saving state.

Jpn. Pat. Appln. KOKAI Publication No. 2005-116014, for example, discloses a technique (prior art) for relaxing the conditions for prediction to quicken the prediction that the danger of impact has gone away. However, even if the conditions for the prediction are relaxed, when, for example, a user hand-carries the portable electronic apparatus, the apparatus cannot be shifted to the power saving state, since the acceleration detection circuit cannot issue, for a long time, the prediction that the danger of impact has gone away.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram illustrating an exemplary system configuration of a notebook personal computer, according to a first embodiment of the invention, which can be powered by a battery;

FIG. 2 is a flowchart illustrating an exemplary procedure of controlling the power saving of an acceleration detection circuit incorporated in the first embodiment; and

FIG. 3 is a block diagram illustrating an exemplary system configuration of a notebook personal computer, according to a second embodiment of the invention, which can be powered by a battery.

### DETAILED DESCRIPTION

Various embodiments according to the invention will be described hereinafter with reference to the accompanying drawings. In general, according to one embodiment of the invention, there is provided a portable electronic apparatus containing a hard disk. The hard disk drive includes a head used to read/write data from/to a recording medium. The portable electronic apparatus comprises an acceleration detection circuit configured to detect acceleration undergone by the portable electronic apparatus, and to control the hard disk drive to retract the head from above the recording medium, based on the detected acceleration; means for estimating whether the head is retracted from above the recording medium, based on a power mode set for an interface incorporated in the hard disk drive; and a controller configured to set the acceleration detection circuit in a power saving mode when it is estimated that the head is retracted.

### First Embodiment

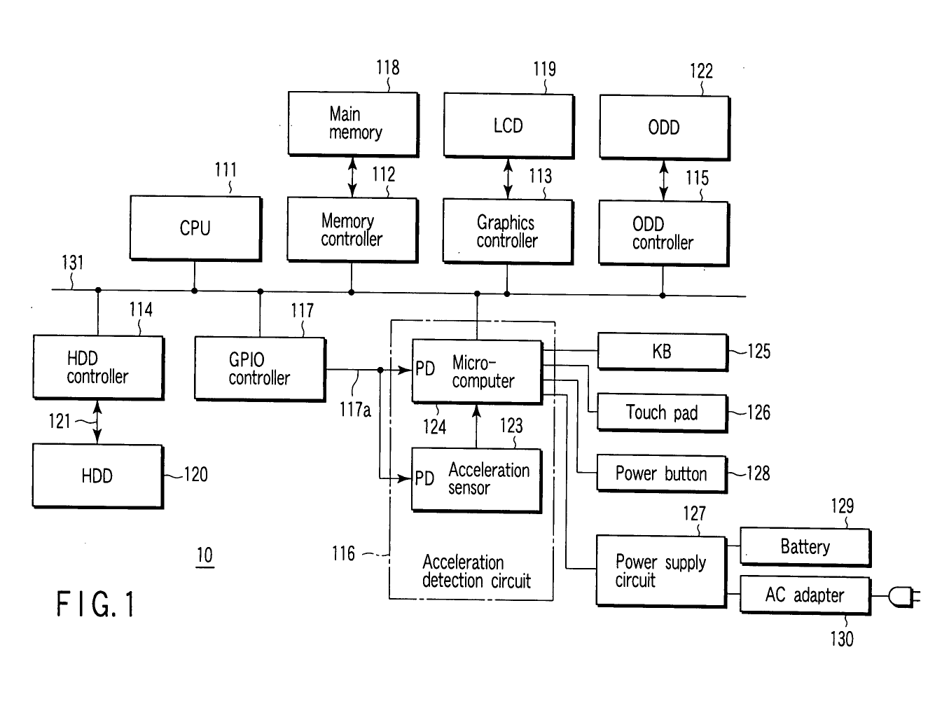

Referring first to FIG. 1, a description will be given of the system configuration of a portable electronic apparatus according to a first embodiment of the invention. The electronic apparatus is realized as, for example, a battery-operated notebook personal computer. As shown in FIG. 1, the computer 10 comprises a CPU 111, main controller 112, graphics controller 113, hard disk drive controller (HDD controller) 114, optical disk drive controller (ODD controller) 115, acceleration detection circuit 116 and general-purpose input/output controller (GPIO controller) 117.

The CPU 111 is a processor for controlling the operation of the computer 10. The CPU 111 executes an operating system (OS) loaded from a boot device to the main memory 118. In the first embodiment, a hard disk drive (HDD) 120, described later, is used as the boot device. The CPU 111 executes various application programs and a Basic Input/Output System (BIOS). The BIOS is a program for hardware control.

The memory controller 112 controls access to the main memory 118. The graphics controller 113 is a display controller for controlling a liquid crystal display (LCD) 119. The LCD 119 is used as the display monitor of the computer 10.

The HDD controller 114 controls access to the HDD 120. The HDD controller 114 and HDD 120 are connected to each other via an HDD interface (HDD I/F) 121 such as an AT attachment (ATA) interface or serial ATA (SATA) interface. The HDD 120 is a storage unit for storing various software and data items. The HDD 120 reads/writes data from/to a magnetic recording medium (magnetic disk) spun by a motor, using a head (magnetic head). The HDD 120 prestores the OS.

The ODD controller 115 controls access to an optical disk drive (ODD) 122. The ODD 122 is a drive unit for spinning, using a motor, an optical recording medium (optical disk), such as a compact disk (CD) or digital versatile disk (DVD). The ODD 122 reads/writes data from/to an optical disk, using a head (optical head).

The acceleration detection circuit 116 is used to predict, for example, impact affecting the computer 10, and to protect the HDD 120 based on the prediction. The acceleration detection circuit 116 includes an acceleration sensor 123 and microcomputer 124. The accelerator sensor 123 and microcomputer 124 support a power-down mode for power saving. To this end, the accelerator sensor 123 and microcomputer 124 each include a power-down mode terminal PD that permits the power-down mode to be designated from the outside.

In a non-power-down mode (i.e., normal mode), the acceleration sensor 123 detects acceleration undergone by the computer 10. The computer 10 undergoes acceleration when vibration or impact is exerted on the case, or when free fall of the computer 10 occurs. The microcomputer 124 is formed by, for example, integrating, in a single chip, an embedded controller and keyboard controller. The embedded controller manages the power supply of the computer 10, and manages/protects the HDD 120. The keyboard controller controls a keyboard (KB) 125 and touch pad 126.

In the normal mode, the microcomputer 124 predicts, for example, the impact exerted on the computer 10 (HDD 120), based on the acceleration detected by the acceleration sensor 123 (i.e., the output of the acceleration sensor 123), and performs control for protecting the HDD 120 based on the prediction result. In this embodiment, the microcomputer 124 performs control for retracting the head, incorporated in the HDD 120, from above a recording medium to a preset retract area. Further, the microcomputer 124 has a power-supply control function, realized by cooperating with a power supply circuit 127, for powering on the computer 10 in response to, for example, a user's operation of a power-button switch 128.

The power supply circuit 127 generates a system power supply voltage to be applied to each component of the computer 10, using a power supply voltage applied by a battery 129 or an AC adaptor 130. The GPIO controller 117 sets the acceleration detection circuit 116 in the normal mode or power saving mode in accordance with a preset control signal (general-purpose output signal) 117a under the control of the CPU 111.

The CPU 111, memory controller 112, the graphics controller 113, the HDD controller 114, the ODD controller 115, the microcomputer 124 of the acceleration detection circuit 116, and the GPIO controller 117 are connected to each other via a system bus 131.

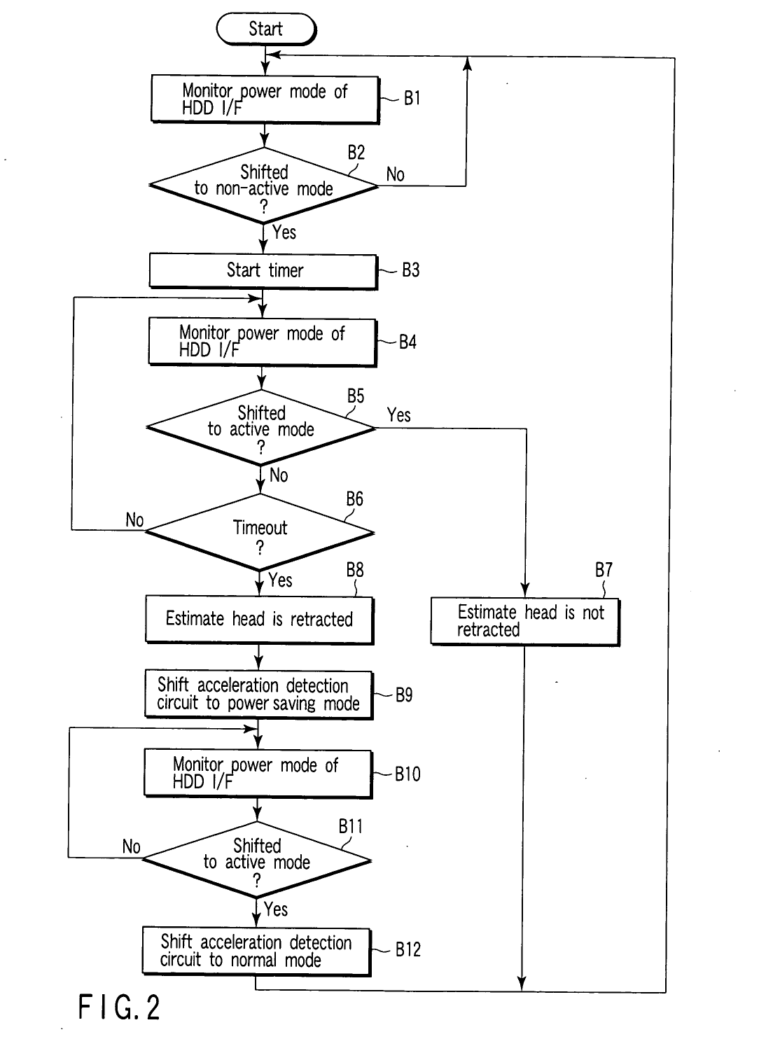

Referring to the flowchart of FIG. 2, a description will be given of the procedure of controlling the power saving of the acceleration detection circuit 116, employed in the first embodiment, using, as an example, the case where the HDD interface 121 is an ATA (parallel ATA) interface. Firstly, at block B1, the CPU 111 monitors the power mode of the HDD interface 121.

The HDD interface 121 can assume two power modes, i.e., an active mode and non-active mode. The active mode is a mode in which data can be read/written from/to the HDD 120. The non-active mode is a mode in which reading/writing data from/to the HDD 120 is inhibited. The non-active mode is a kind of power saving mode, and mainly includes an idle mode, standby mode and sleep mode. The power consumption is decreased in the order of the idle mode, standby mode and sleep mode.

At block B2, the CPU 111 determines whether the HDD interface 121 is shifted from the active mode to the non-active mode, based on the monitoring result acquired at block B1 concerning the power mode of the HDD interface 121. Until determining (detecting) that the HDD interface 121 is shifted from the active mode to the non-active mode, the CPU 111 iterates, for example, periodically, the monitoring of the power mode of the HDD interface 121 at block B1. Upon determining at block B2 that the HDD interface 121 is shifted from the active mode to the non-active mode, the CPU 111 proceeds to block B3.

The shift of the HDD interface 121 from the active mode to the non-active mode (idle mode, standby mode or sleep mode) is determined by detecting the issue of an ATA power saving command. The ATA power saving command is a particular command for designating a power saving mode (ATA power saving mode), and is issued from the HDD controller 114 to the HDD 120.

More specifically, the shift to the idle mode can be determined by detecting the issue of an IDLE command or IDLE IMMEDIATE command. Similarly, the shift to the standby mode can be determined by detecting the issue of a STANDBY command. Alternatively, the shift to the standby mode may be determined by detecting that a standby timer contained in the HDD controller 114 measures a preset time designated by a STANDBY IMMEDIATE command, i.e., by detecting the timeout of the standby timer. Further, the shift to the sleep mode can be determined by detecting the issue of a SLEEP command. The shift to these modes can also be determined by, for example, periodically sending, from the CPU 111 to the HDD controller 114, a Check Power Mode command inquiring the power mode of the HDD interface 121.

At block B3, the CPU 111 activates a timer (not shown). The timer, in turn, starts to measure a preset time T. The time T can be set to an arbitrary value by a user's operation.

At the next block B4, the CPU 111 again monitors the power mode of the HDD interface 121. At block B5, the CPU 111 determines whether the HDD interface 121 is shifted from the non-active mode to the active mode, based on the monitoring result concerning the power mode of the HDD interface 121. The shift of the HDD interface 121 from the non-active mode to the active mode is determined by detecting the issue, from the HDD controller 114 to the HDD 120, of a command requesting access to a recording medium.

If the HDD interface 121 is not yet shifted to the active mode (block B5), the CPU 111 determines at block B6 whether the timeout of the timer occurs, i.e., whether the timer has measured the time T. If the timeout of the timer does not occur (block B6), the CPU 111 returns to block B4, and monitors the power mode of the HDD interface 121. In contrast, if the timeout of the timer occurs (block B6), the CPU 111 proceeds to block B8. On the other hand, if the HDD interface 121 is shifted to the active mode (block B5), the CPU 111 proceeds to block B7.

Thus, within the time T as an upper limit, the CPU 11 iterates, for example, periodically, the processes (of blocks B4 and B5) of monitoring the power mode of the HDD interface 121 and determining whether the HDD interface 121 is shifted to the active mode (block B6). These processes are executed to confirm whether the HDD interface 121 is kept in the non-active mode over the time T, thereby estimating whether the head of the HDD 120 is retracted from above a recording medium as described later.

At present, there is no means for enabling the CPU 111 (host system) to directly confirm whether the head of the HDD 120 is retracted. Therefore, in the first embodiment, the CPU 111 estimates whether the head of the HDD 120 is retracted, in the following manner.

Firstly, assume that by the time when the time T elapses, i.e., by the time when the timeout of the timer occurs, the HDD interface 121 is shifted to the active mode (block B5). In this case, at block B7, the CPU 111 estimates that the head temporarily retracted from above the recording medium of the HDD 120 is again shifted to above the medium. In this state, reading/writing of data from/to the HDD 120 is possible. After the estimation at block B7, the CPU 111 returns to block B1.

In contrast, if the HDD interface 121 is not shifted to the active mode even after the time T elapses (blocks B5 and B6), the CPU 111 estimates at block B8 that the head of the HDD 120 is retracted from above the recording medium. Namely, if the HDD interface 121 is still in the non-active mode even after the time T elapses, the CPU 111 estimates that the head is retracted.

If the CPU 111 estimates that head is retracted (i.e., if the CPU 111 estimates a particular state) (block B8), it determines that it is not necessary to operate the acceleration detection circuit 116 in the normal mode. At the next block B9, the CPU 111 shifts the acceleration detection circuit 116 from the normal mode to the power saving mode. However, at this time, concerning the microcomputer 124 included in the acceleration detection circuit 116, only a partial block is shifted to the power saving mode. Namely, among the blocks of the embedded controller included in the acceleration detection circuit 116, only a block (particular block) having a function for protecting/managing the HDD 120 is shifted to the power saving mode, while the other blocks of the embedded controller and the keyboard controller included in the microcomputer 124 are kept in the normal mode.

The reason why it is not necessary to operate the acceleration detection circuit 116 in the normal mode when the head is retracted is that when the head is retracted, the head or recording medium will not be damaged even if impact, for example, is continuously exerted on the computer 10 when the computer is on.

At block B9, the CPU 111 performs the following process, using the GPIO controller 117: Firstly, the CPU 111 instructs the GPIO controller 117 to shift the acceleration detection circuit 116 to the power saving mode. In accordance with the instruction, the GPIO controller 117 asserts a control signal 117a. The control signal 117a is input to the power-down mode terminal PD of the acceleration sensor 123 of the acceleration detection circuit 116 and to the power-down mode terminal PD of the microcomputer 124. When the control signal 117a input to the power-down mode terminals PD is asserted, the acceleration sensor 123 and microcomputer 124 are set in the power saving mode (i.e., the power-down mode). This is equivalent to the setting, in the power saving mode (power-down mode), of the acceleration detection circuit 116 formed of the acceleration sensor 123 and microcomputer 124.

Assume that the acceleration detection circuit 116 is set in the power saving mode by the process of block B9. At this time, even if impact, for example, is continuously exerted on the computer 10 when the computer is, for example, hand-carried and kept in the on state, the power consumption of the acceleration detection circuit 116 can be reduced. This leads to the power saving of the computer 10.

As described above, in the first embodiment, when the particular state, in which the head of the HDD 120 is retracted, is estimated based on the state (power mode) of the HDD interface 121, the acceleration detection circuit 116 is shifted from the normal mode to the power saving mode. This mode shift (switch) prevents the HDD 120 from being influenced by, for example, impact affecting the computer 10, and enables power saving of the computer 10.

In particular, when the computer (notebook personal computer) 10 is used in a normal state, the HDD 120 is not accessed in a greater part of the power-on period of the computer 10. While the HDD 120 is not accessed, the head of the HDD 120 is substantially retracted from above a recording medium. Accordingly, when the acceleration detection circuit 116 is incorporated in the computer 10 as in the first embodiment, even if the computer 10 is in the on state, the time of powering the computer 10 by the battery 129 can be increased by setting the acceleration detection circuit 116 in the power saving mode while the head of the HDD 120 is retracted from above the recording medium.

After executing block B9, the CPU 111 proceeds to block B10, where it monitors the power mode of the HDD interface 121 as at block B1. Assume here that when the CPU 111 monitors the power mode of the HDD interface 121 at block B10, the HDD interface 121 is shifted from the non-active mode to the active mode. When the HDD interface 121 is shifted to the active mode, the head of the HDD 120 may be moved to above the recording medium. In this case, it is necessary to operate the acceleration detection circuit 116 in the normal mode.

Accordingly, when the CPU 111 monitors the power mode of the HDD interface 121 and determines (detects) that the HDD interface 121 is shifted from the non-active mode to the active mode (blocks B10 and B11), it proceeds to block B12. At block B12, the CPU 111 predicts the loading (movement) of the head to the recording medium, and shifts the acceleration detection circuit 116 from the power saving mode to the normal mode.

The CPU 111 executes block B12 as follows, using the GPIO controller 117. Firstly, the CPU 111 instructs the GPIO controller 117 to shift the acceleration detection circuit 116 to the normal mode. In accordance with the instruction, the GPIO controller 117 deasserts the control signal 117a. When the control signal 117a is deasserted, the accelerator sensor 123 and microcomputer 124 are set in the normal mode.

After executing block B12, the CPU 111 returns to block B1, where it monitors the power mode of the HDD interface 121.

When the timer has measured the time T and the timeout of the timer has occurred, the CPU 111 may issue, for example, a Check Power Mode command to the HDD controller 114. Upon receiving the Check Power Mode command from the CPU 111, the HDD controller 114 reports the current power mode of the HDD interface 121 to the CPU 111 in reply to the command. Thus, the CPU 111 issues the Check Power Mode command to the HDD controller 114 to detect the power mode of the HDD interface 121. At this time, based on the detected power mode, the CPU 111 determines whether the HDD interface 121 is shifted to the active mode. As a result of the determination, the CPU 111 estimates whether the head is retracted.

In the first embodiment, it is assumed that the HDD interface 121 is an ATA (parallel ATA) interface. Also when the HDD interface 121 is a serial ATA (SATA) interface, the power saving of the acceleration detection circuit 116 can be realized. In this case, however, different methods must be employed between the ATA interface and SATA interface for determining (detecting) the shift to the non-active mode and the shift to the active mode. A description will now be given of a method for determining the shift of the HDD interface 121 to the non-active mode and to the active mode, employed when the HDD interface 121 is an SATA interface.

In the SATA interface standards, three functional layers, i.e., a physical layer, link layer and transport layer, are defined. The physical layer has a function for executing high-rate signal transmission and reception. The physical layer interprets received data and sends it to the link layer. The physical layer also outputs a serial data signal in response to a request from the link layer. The link layer supplies the physical layer with a request to output a signal in response to a request from the transport layer, and also supplies the transport layer with the signal received from the physical layer. The transport layer performs conversion for operations based on the ATA standards.

In the SATA interface, the non-active mode includes a partial mode and slumber mode. The shift to the partial mode is determined by detecting that a partial signal is asserted by the link layer. Similarly, the shift to the slumber mode is determined by detecting that a slumber signal is asserted by the link layer. Namely, the shift to the non-active mode is determined by detecting that the partial or slumber signal is asserted. On the other hand, the shift to the active mode is determined by detecting that the partial or slumber signal is deasserted.

### Second Embodiment

In the first embodiment, it is assumed that the accelerator sensor 123 and microcomputer 124 of the acceleration detection circuit 116 support the power-down mode for power saving, and include the respective power-down mode terminals PD. Accordingly, if the accelerator sensor 123 and microcomputer 124 do not support the power-down mode, power saving of the acceleration detection circuit 116 as in the first embodiment cannot be realized.

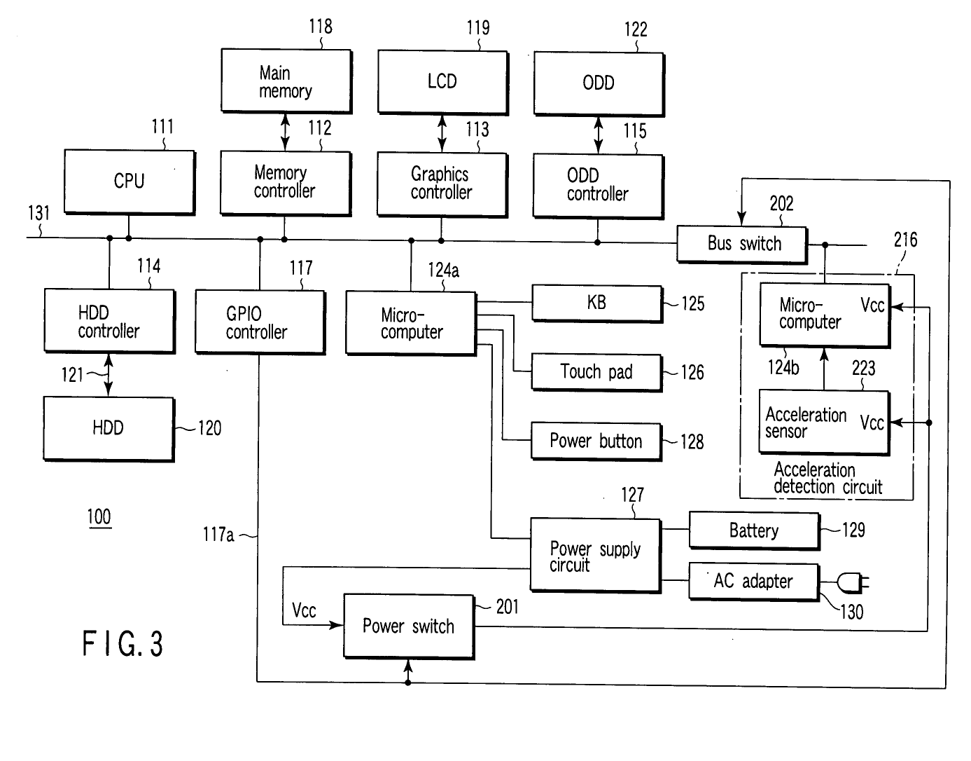

A second embodiment is constructed such that power saving of the acceleration detection circuit 116 is realized even if the accelerator sensor 123 and microcomputer 124 do not support the power-down mode. Referring to FIG. 3, the thus-constructed second embodiment will be described. FIG. 3 is a block diagram illustrating the system configuration of a notebook personal computer 100, according to the second embodiment of the invention, which can be powered by a battery. In FIGS. 1 and 3, like reference numbers denote like elements. A description will be given only of the elements included in the computer 100 shown in FIG. 3 and differing from those of the computer 10 shown in FIG. 1.

In the computer 100 of FIG. 3, an acceleration sensor 223 is used instead of the acceleration sensor 123 in FIG. 1, and microcomputers 124a and 124b are used instead of the microcomputer 124 in FIG. 1. The microcomputer 124a has a function for managing the power supply of the computer 100, and does not have a function for protecting the HDD 120. The microcomputer 124b has a function for protecting the HDD 120, and does not have a function for managing the power supply of the computer 100.

As mentioned above, the microcomputer 124b has the function for protecting the HDD 120, which is included in the functions of the microcomputer 124 of the first embodiment. The microcomputer 124b and acceleration sensor 223 provides an acceleration detection circuit 216 that corresponds to the acceleration detection circuit 116 shown in FIG. 1. However, assume that the microcomputer 124b and acceleration sensor 223 do not support the power-down mode, namely, the acceleration detection circuit 216 does not support the power-down mode.

The computer 100 shown in FIG. 3 includes a power switch 201 and bus switch 202. The power switch 201 is provided across a power supply line for applying a power supply voltage Vcc, generated by the power supply circuit 127, to the microcomputer 124b and acceleration sensor 223 of the acceleration detection circuit 216. The power switch 201 is turned on/off in accordance with the control signal 117a output from the GPIO controller 117. By the turn-on and -off of the switch 201, the application of the power supply voltage Vcc, generated by the power supply circuit 127, to the microcomputer 124b and acceleration sensor 223, and the interruption of the voltage Vcc are performed.

The bus switch 202 is used to connect/disconnect the microcomputer 124b of the acceleration detection circuit 216 to/from a system bus 131. The bus switch 202 is turned on and off in accordance with the control signal 117a output from the GPIO controller 117. In accordance with the turn-on and -off of the bus switch 202, the microcomputer 124b is connected/disconnected to/from the system bus 131.

A description will be given of only the operation of the second embodiment that differs from the first embodiment. The procedure shown in FIG. 2 is used both in the first and second embodiments. The second embodiment differs from the first embodiment only in the method for controlling the mode of the microcomputer 124b and acceleration sensor 223 employed at blocks B9 and B12.

Assume here that the CPU 111 has detected the timeout at block B6. This means that the HDD interface 121 is still in the non-active mode even after the time T elapses. Therefore, the CPU 111 estimates at block B8 that the head of the HDD 120 is retracted from above the recording medium. At the next block B9, the CPU 111 shifts the microcomputer 124b and acceleration sensor 223 of the acceleration detection circuit 216 from the normal mode to the power saving mode as follows:

Firstly, the CPU 111 instructs the GPIO controller 117 to shift the acceleration detection circuit 216 to the power saving mode. In accordance with the instruction, the GPIO controller 117 deasserts the control signal (general-purpose output signal) 117a. In the second embodiment, the control signal 117a is used to turn on/off the power switch 201 and bus switch 202. If the control signal 117a is deasserted as in this case, the power switch 201 and bus switch 202 are turned off.

When the power switch 201 is off, the application of the power supply voltage Vcc by the power supply circuit 127 to the acceleration sensor 223 and microcomputer 124b is interrupted. As a result, power saving of the acceleration sensor 223 and microcomputer 124b is realized. This is equivalent to the setting of the acceleration sensor 223 and microcomputer 124b (i.e., the acceleration detection circuit 216) in the power saving mode. At the same time, the bus switch 202 is turned off, whereby the microcomputer 124b is isolated from the system bus 131.

After executing block B9, the CPU 111 proceeds to block B10, where it monitors the power mode of the HDD interface 121. If the CPU 111 determines from the monitoring result that the HDD interface 121 is shifted to the active mode (block B11), it proceeds to block B12. At block B12, the CPU 111 shifts the acceleration sensor 223 and microcomputer 124b of the acceleration detection circuit 216 from the power saving mode to the normal mode in the following manner.

Firstly, the CPU 111 instructs the GPIO controller 117 to shift the acceleration detection circuit 116 to the normal mode. In accordance with the instruction, the GPIO controller 117 asserts the control signal 117a. When the control signal 117a is asserted, the power switch 201 and bus switch 202 are turned on.

When the power switch 201 is turned on, the power supply voltage Vcc, generated by the power supply circuit 127, is applied to the acceleration sensor 223 and microcomputer 124b. At the same time, the bus switch 202 is turned on, thereby connecting the microcomputer 124b to the system bus 131. This state is equivalent to the setting of the acceleration sensor 223 and microcomputer 124b (i.e., the acceleration detection circuit 216) in the normal mode.

In the first and second embodiments, it is assumed that the portable electronic apparatus is a notebook personal computer that can be powered by a battery. However, the portable electronic apparatus may be a portable audio player, portable video player, portable terminal or mobile phone. It is sufficient if the portable electronic apparatus can be powered by a battery. Such portable electronic apparatuses as a portable audio player, portable video player, etc., consume less power than a notebook personal computer. Further, the ratio of the power consumption of the acceleration detection circuit to that of the entire machine in those apparatuses is higher than in the notebook personal computer. Accordingly, they may well provide a higher power saving effect than the notebook personal computer if the power consumption of the acceleration detection circuit is reduced.

While certain embodiments of the inventions have been described, they have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from the spirit of the inventions. The accompanying claims and their equivalents are intended to cover such forms or modifications as would fall within the scope and spirit of the inventions.

What is claimed is:

1. A portable electronic apparatus containing a hard disk drive, the hard disk drive including a head used to read/write data from/to a recording medium, comprising:
an acceleration detection circuit configured to detect acceleration undergone by the portable electronic apparatus, and to control the hard disk drive to retract the head from above the recording medium, based on the detected acceleration;
means for estimating whether the head is retracted from above the recording medium, based on a power mode set for an interface incorporated in the hard disk drive; and
a controller configured to set the acceleration detection circuit in a power saving mode when it is estimated that the head is retracted.

2. The portable electronic apparatus according to claim 1, further comprising means for monitoring the power mode set for the interface, the power mode including an active mode which permits reading/writing of data from/to the hard disk drive, and a non-active mode which inhibits the reading/writing of data from/to the hard disk drive,
wherein the estimating means estimates that the head is retracted, when the interface is not shifted to the active mode within a preset time of the interface being shifted from the active mode to the non-active mode.

3. The portable electronic apparatus according to claim 2, wherein the controller sets the acceleration detection circuit in a normal mode when the interface is shifted from the non-active mode to the active mode after the acceleration detection circuit is set in the power saving mode.

4. The portable electronic apparatus according to claim 3, further comprising:
means for measuring the preset time when the interface is shifted from the active mode to the non-active mode; and
means for determining whether the interface is shifted to the active mode within the preset time,
wherein the estimating means estimates that the head is retracted, when it is determined that the interface is not shifted to the active mode within the preset time.

5. The portable electronic apparatus according to claim 4, further comprising means for determining whether the interface is shifted from the active mode to the non-active mode, based on the monitoring result of the monitoring means concerning the power mode,
wherein the measuring means starts to measure the preset time when it is determined that the interface is shifted from the active mode to the non-active mode.

6. The portable electronic apparatus according to claim 1, wherein the acceleration detection circuit includes:
an acceleration sensor which detects the acceleration undergone by the portable electronic apparatus; and
a microcomputer configured to control the hard disk drive to retract the head from above the recording medium, based on the detected acceleration.

7. The portable electronic apparatus according to claim 1, wherein:
the acceleration detection circuit supports a power-down mode; and
the controller sets the acceleration detection circuit in the power saving mode by setting the acceleration detection circuit in the power-down mode.

8. The portable electronic apparatus according to claim 1, further comprising a power switch used to apply a power supply voltage to the acceleration detection circuit and to interrupt application of the power supply voltage to the acceleration detection circuit,
wherein the controller sets the acceleration detection circuit in the power saving mode by controlling the power switch to interrupt the application of the power supply voltage to the acceleration detection circuit.

9. A method of controlling power saving of an acceleration detection circuit, for use in a portable electronic apparatus containing a hard disk drive, the acceleration detection circuit detecting acceleration undergone by the portable electronic apparatus, and controlling the hard disk drive to retract the head from above the recording medium, based on the detected acceleration, the method comprising;
estimating whether the head is retracted from above the recording medium, based on a power mode set for an interface incorporated in the hard disk drive; and
setting the acceleration detection circuit in a power saving mode when it is estimated that the head is retracted.

10. The method according to claim 9, further comprising:
monitoring the power mode set for the interface, the power mode including an active mode which permits reading/writing of data from/to the hard disk drive, and a non-active mode which inhibits the reading/writing of data from/to the hard disk drive;
determining whether the interface is shifted from the active mode to the non-active mode;
monitoring the power mode set for the interface within a preset time as an upper limit, when it is determined that the interface is shifted from the active mode to the non-active mode; and
determining whether the interface is shifted to the active mode within the preset time of the interface being shifted from the active mode to the non-active mode,
wherein retraction of the head is estimated when the interface is not shifted to the active mode within the preset time.

11. The method according to claim 10, further comprising:
monitoring the power mode set for the interface, after the acceleration detection circuit is set in the power saving mode;
determining whether the interface is shifted from the non-active mode to the active mode, based on the monitoring result concerning the power mode acquired after the acceleration detection circuit is set in the power saving mode; and
setting the acceleration detection circuit in a .normal mode when it is determined that the interface is shifted from the non-active mode to the active mode.

12. The method according to claim 9, wherein:
the acceleration detection circuit supports a power-down mode; and
the acceleration detection circuit is set in the power saving mode when the acceleration detection circuit is set in the power-down mode.

13. The method according to claim 9, wherein the acceleration detection circuit is set in the power saving mode by interrupting of application of a power supply voltage to the acceleration detection circuit.
